(19) United States
(12) Patent Application Publication
(10) Pub. No.: US 2018/0081448 A1
(43) Pub. Date: Mar. 22, 2018

(54) AUGMENTED-REALITY-BASED INTERACTIVE AUTHORING-SERVICE-PROVIDING SYSTEM

(71) Applicant: Korea Advanced Institute of Science and Technology, Daejeon (KR)

(72) Inventors: Woon Tack WOO, Daejeon (KR); Kyung Won GIL, Daejeon (KR); Tae Jin HA, Daejeon (KR); Young Yim DOH, Daejeon (KR); Ji Min RHIM, Daejeon (KR)

(21) Appl. No.: 15/563,782

(22) PCT Filed: Sep. 14, 2015
(86) PCT No.: PCT/KR2015/009610

§ 371 Date: Oct. 2, 2017

(30) Foreign Application Priority Data
Apr. 3, 2015 (KR) 10-2015-0047712

(51) Int. Cl. G06F 3/01; G02B 27/01; G06T 19/00; G06F 3/0481; G06F 3/0484; G06F 3/046; G06F 3/0487; G06F 3/0346

(52) U.S. Cl. CPC G06F 3/017; G02B 27/0172; G06T 19/006; G06F 3/04815; G02B 2027/0138; G06F 3/04842; G06F 3/046; G06F 3/0487; G06F 3/0346; G06F 3/011

(57) ABSTRACT

The present invention includes: a wearable device including a head mounted display (HMD); an augmented reality service providing terminal paired with the wearable device and configured to reproduce content corresponding to a scenario-based preset flow via a GUI interface, overlay corresponding objects in a three-dimensional (3D) space being viewed from the wearable device when an interrupt occurs in an object formed in the content to thereby generate an augmented reality image, convert a state of each of the overlaid objects according to a user's gesture, and convert location regions of the objects based on motion information sensed by a motion sensor; and a pointing device including a magnetic sensor and configured to select or activate an object output from the augmented reality service providing terminal.

### CROSS-REFERENCE TO RELATED APPLICATIONS

The present specification is a U.S. National Stage of International Patent Application No. PCT/KR2015/009610 filed on Sep. 14, 2015, which claims priority to and the benefit of Korean Patent Application No. 10-2015-0047712 filed on Apr. 3, 2015, the entire contents of which are incorporated herein by reference.

### TECHNICAL FIELD

The present invention relates to an augmented reality (AR)-based interactive authoring service which enables role playing.

### BACKGROUND ART

Augmented reality (AR) refers to a computer graphics technique that combines a virtual object or information into a real environment and makes it appear as if an object exists in an original environment.

In such an AR system environment, users can interact with three-dimensional (3D) objects in various points of view so as to enhance their understanding. For example, AR applications for science education can allow users to observe 3D animals in detail by using an AR marker serving as a magnifier.

As such, AR-based e-books can extend virtual 3D objects on traditional paper books and provide a real environment for readers with reference to pop-up books. However, there is a lack of research on interactive story telling and specific story-based role playing that can express the user's own emotions, allow users to experience emotions of other persons through empathy, or can allow users to communicate with each other in a specific scenario deployment method.

### DETAILED DESCRIPTION OF THE INVENTION

### Technical Problem

The present invention relates to an augmented reality (AR)-based interactive authoring service which enables role playing, and more particularly, provides an augmented reality service technology that can perform operations associated with story telling and role playing, so as to enhance understanding based on education and learning in an AR environment, express a user's own emotions through interaction with 3D objects, and experience emotions of other persons.

### Technical Solution

According to one aspect of the present invention, an augmented-reality-based interactive authoring-service-providing system includes: a wearable device including a head mounted display (HMD); an augmented reality service providing terminal paired with the wearable device and configured to reproduce content corresponding to a scenario-based preset flow via a GUI interface, overlay corresponding objects in a 3d space being viewed from the wearable device when an interrupt occurs in an object formed in the content to thereby generate an augmented reality image, convert a state of each of the overlaid objects according to a user's gesture, and convert location regions of the objects based on motion information sensed by a motion sensor; and a pointing device including a magnetic sensor and configured to select or activate an object output from the augmented reality service providing terminal.

### Advantageous Effects

The present invention has an effect that can provide an augmented reality service capable of performing interaction based on a user's gesture, so as to enhance understanding based on education and learning in an AR environment, express a user's own emotions through interaction with 3D objects, and experience emotions of other persons.

### DESCRIPTION OF THE DRAWINGS

FIG. 1A is an overall configuration diagram of an augmented-reality-based interactive authoring-service-providing system to which the present invention is applied.

FIG. 1B is showing objects formed in image data corresponding to multimedia service-based content output from the augmented reality service providing terminal according to an embodiment of the present invention.

FIG. 2 is a detailed block diagram illustrating a configuration of an augmented reality service providing terminal in the augmented-reality-based interactive authoring-service-providing system according to an embodiment of the present invention.

FIG. 3 is a diagram illustrating an example of a screen showing a first operation in an interaction mode in the augmented-reality-based interactive authoring-service-providing system according to an embodiment of the present invention.

FIG. 4A is a diagram illustrating an example of a screen showing a second operation in an interaction mode in the augmented-reality-based interactive authoring-service-providing system according to an embodiment of the present invention.

FIG. 4B is a diagram illustrating another example of a screen showing a second operation in an interaction mode in the augmented-reality-based interactive authoring-service-providing system according to an embodiment of the present invention.

FIG. 5A is a photograph showing a position of the first tracking unit according to the present invention.

FIG. 5B is a photograph showing another position of the first tracking unit according to the present invention.

### MODE OF THE INVENTION

Hereinafter, preferred embodiments of the present invention will be described in detail with reference to the accompanying drawings. In the following description, particular matters such as specific elements are provided, but they are provided only for easy understanding of the present invention. It is obvious to those skilled in the art that these particular matters can be modified or changed without departing from the scope of the present invention.

The present invention relates to an augmented reality (AR)-based interactive authoring service which enables role playing, and more particularly, provides an augmented reality service technology capable of performing interaction based on mutual user gesture, so as to perform operations associated with story telling and role playing for enhancing understanding based on education and learning in an AR environment, expressing a user's own emotions through interaction with 3D objects, and experiencing emotions of other persons, wherein an augmented reality service providing terminal paired with a wearable device including a head mounted display (HMD) reproduces scenario-based content via a GUI interface, monitors interrupt for each object formed in a current page being reproduced, overlays an object selected through the interrupt by a user in a three-dimensional (3D) space being viewed from the wearable device, changes a state and a location of an object according to a type of a user's gesture by displaying a preset item associated with the overlaid object to be adjacent to the corresponding object.

In addition, the present invention provides a technology that controls the location of each object in the content reproduced according to the type of the user's gesture in a 3D space, converts the facial expression of the object overlaid in the 3D space so as to correspond to the selected item, and applies the converted item to the content, thereby increasing the ability to understand emotions and viewpoints of other persons and the ability to communicate with other persons through story and character control.

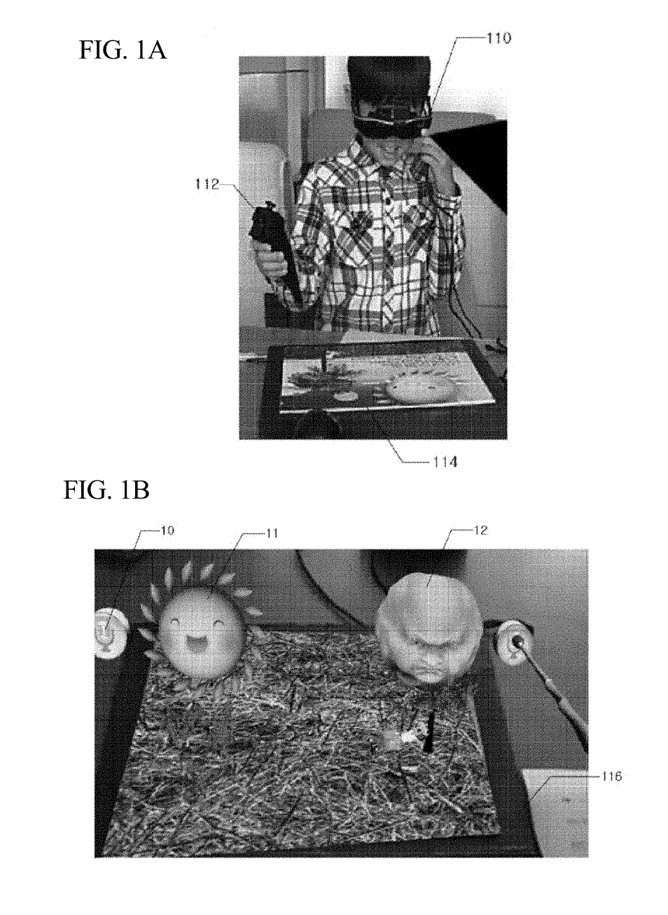

Hereinafter, an augmented-reality-based interactive authoring-service-providing system according to an embodiment of the present invention will be described in detail with reference to FIGS. 1 to 5.

First, FIG. 1A is an overall configuration diagram of an augmented-reality-based interactive authoring-service-providing system to which the present invention is applied.

The system, to which the present invention is applied, includes a user wearable device 110, a pointing device 112, and an augmented reality service providing terminal 114. The user wearable device 110 may include a glass wearable device or a head mount display (HMD).

The wearable device 110 may transmit additional information to a user together with a currently visually observed image by using a see-through information display unit.

In addition, the wearable device 110, to which the present invention is applied, includes a camera and interworks with the augmented reality service providing terminal 114 to provide a mutually complementary multimedia service between the augmented reality service providing terminals 114. The wearable device 110 confirms a location of an object through a sensor such as a GPS, a gyro sensor, an acceleration sensor, or a compass, and the like, and manipulates and views content supported through the augmented reality service providing terminal 114 interworking through a network by using distance information indirectly measured through the camera, based on the corresponding location.

The viewing is to watch a region on which content is displayed on a display screen of the wearable device 110 itself or through the augmented reality service providing terminal 114. All screen display services visually provided to the user through the wearable device 110, multimedia services provided via the Internet, and image information currently visually observed through the camera by the user, for example, displayed from the augmented reality service providing terminal 114 or input according to a movement of a user's gaze, are displayed on the corresponding region.

The pointing device 112 includes a magnetic sensor and selects or activates an object output from the augmented reality service providing terminal 114.

The object is objects 10, 11, and 12 formed in image data 116 corresponding to multimedia service-based content output from the augmented reality service providing terminal 114 as illustrated in FIG. 1B. The content is displayed on a continuous page of an e-book based on a predetermined scenario-based preset flow. According to the present invention, a certain point is contacted, that is, pointed by touch by using the pointing device 112, and an object formed on each page based on the scenario to perform an event is selected or activated. Then, the selected or activated result is input to the augmented reality service providing terminal.

The augmented reality service providing terminal 114 is paired with the wearable device 110 to reproduce content corresponding to the scenario-based preset flow via a GUI interface, overlay corresponding objects in a 3D space being viewed from the wearable device 110 when an interrupt occurs in an object formed in the content to thereby generate an augmented reality image, convert the state of each of the overlaid objects according to a user's gesture, and convert location regions of the objects based on motion information sensed by a motion sensor.

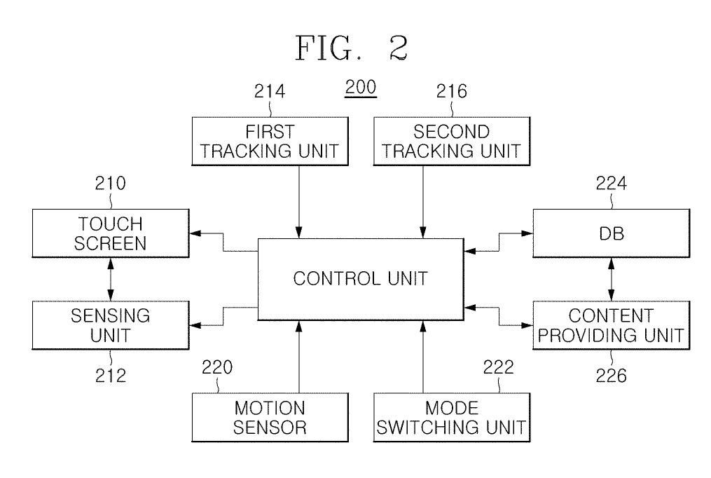

FIG. 2 is a detailed block diagram illustrating the configuration of the augmented reality service providing terminal in the augmented-reality-based interactive authoring-service-providing system according to an embodiment of the present invention.

As illustrated in FIG. 2, the augmented reality service providing terminal 200, to which the present invention is applied, includes a touch screen 210, a sensing unit 212, a first tracking unit 214, a second tracking unit 216, a control unit 218, a motion sensor 220, a mode switching unit 222, a database (DB) 224, and a content providing unit 226.

The sensing unit 212 senses and outputs a type of a user's gesture input through the touch screen 210.

The gesture means “intention” that the user desires to input through an input unit, i.e., the touch screen 210 provided in the augmented reality service providing terminal 200. The gesture is to contact a certain point of the touch screen 210, that is, to point a certain point of the touch screen 210 by touch.

In addition, the gesture is sensed by the motion sensor 220 provided in the augmented reality service providing terminal 200 and may be a user's intention to form a vertical or horizontal state, of which a slope is sensed through the motion sensor 220 of the augmented reality service providing terminal 200.

The gesture may be an action of changing the location and state of the object displayed on the augmented reality image through the pointing device.

As described above, according to the present invention, the type of the user's gesture is sensed through the sensing unit 212, and a result of sensing the type of the user's gesture is output to the control unit 218 so as to perform the corresponding operation.

The first tracking unit 214 is provided at a location opposite to the screen on which the GUI interface is displayed, that is, the touch screen 210, and detects a pose of an object formed on each page corresponding to the content, which is supported from the content providing unit 226 and being reproduced, at each preset period.

The first tracking unit 214, to which the present invention is applied, is attached to the rear surface of the augmented reality service providing terminal 200 to detect a pose of an object formed on each continuous page of content provided as an augmented reality image based on an image being viewed on the wearable device, verify whether the detected pose is converted based on the corresponding pose of the object formed on each page of the content prestored in the DB 224, and apply the verified conversion result to the corresponding page.

The second tracking unit 216 senses and outputs a magnetic sensor movement path of the interworking pointing device. The second tracking unit 216 senses a magnetic sensor provided in the moving pointing device in real time so as to control the object in the augmented reality image range displayed on the region being viewed from the wearable device, and outputs sensing data of the pointing device to the control unit 218.

As described above, the tracking units 214 and 216, to which the present invention is applied, can perform image tracking and sensor tracking at the same time. The tracking units 214 and 216 sense sensor data through a magnetic tracker, acquire conversion information of sensing data for each tracked object from the DB 224, and reflect the acquired conversion information to the corresponding page.

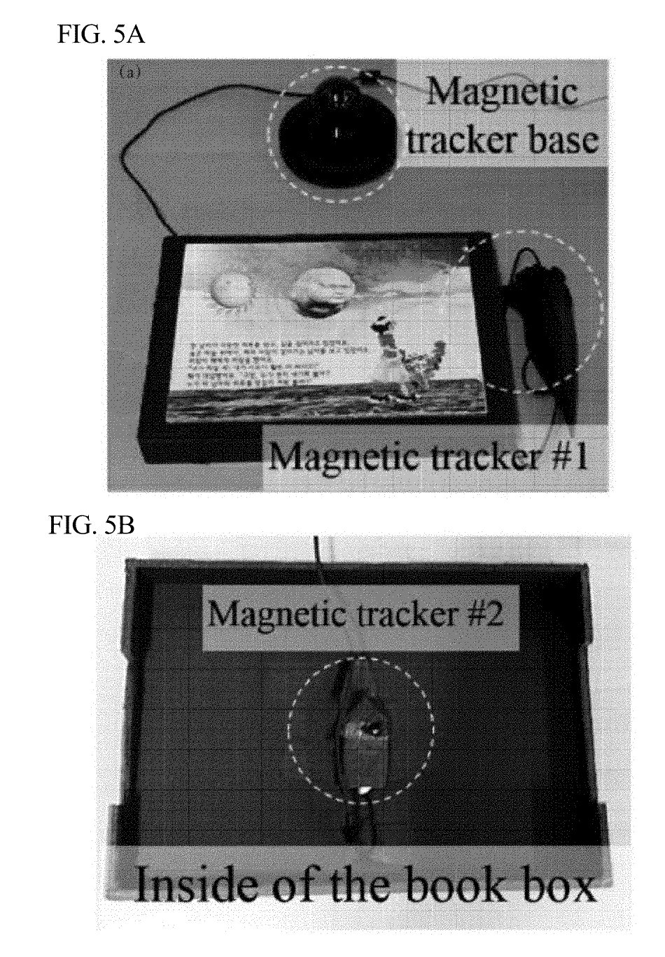

Meanwhile, according to the present invention, the first tracking unit 214 may be provided in association with the inside or the outside of the augmented reality service providing terminal, as illustrated in a) and b) of FIG. 5A and 5B.

The control unit 218 controls the location of the object as content or a 3D space according to the type of the user's gesture sensed by the sensing unit 212, displays a preset facial expression item for each object so as to be adjacent to the object overlaid in the 3D space, converts the object so as to correspond to the facial expression item selected from the displayed items by the user, and applies the converted object to the content.

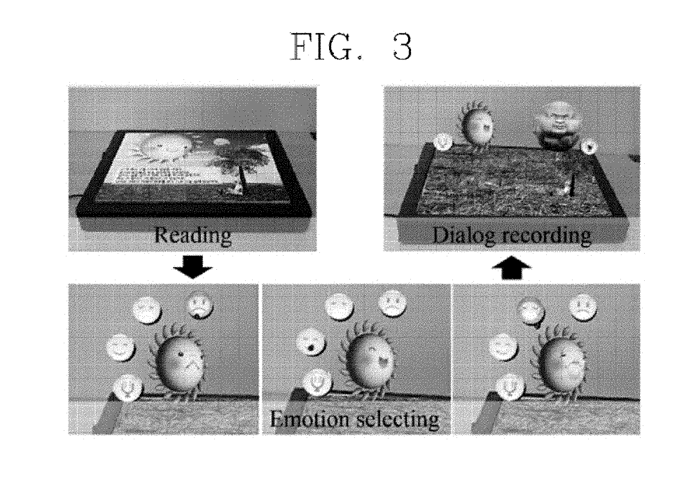

FIG. 3 is a diagram illustrating an example of a screen showing an operation in an interaction mode in the augmented-reality-based interactive authoring-service-providing system according to an embodiment of the present invention.

As illustrated in FIG. 3, in a reading operation, predetermined content corresponding to the scenario-based preset flow selected through the GUI interface by the user is reproduced on the touch screen of the augmented reality service providing terminal.

In an emotion selecting operation, a preset facial expression item for each object is displayed to be adjacent to the object overlaid in the 3D space through the user interrupt on a predetermined page corresponding to the content displayed on the touch screen in the reading operation, the object is converted to correspond to the facial expression item selected from the displayed items by the user, and the converted object is applied to the content.

At this time, the preset facial expression is at least an expression of surprise, fear, sadness, anger, laugher, and the like, and a plurality of facial expression items for each object included in content are supported from the DB 224. Therefore, the control unit 218 extracts a preset facial expression item for the object, which is selected by the user and displayed on the augmented reality image, from the DB 224, displays the facial expression item so as to be adjacent to the corresponding object, converts the facial expression of the object so as to correspond to the selected facial expression item, and applies the converted facial expression as the facial expression of the object in the page output on the touch screen 210.

In addition, the control unit 218 acquires and applies pose information of the converted object according to the user's gesture through the DB which stores standard pose information for each object included in the scenario-based content.

Meanwhile, the control unit 218 sets up the pose of each object of the augmented reality image and the pointing device in a pose setting region, and perform control so that the scene of the augmented reality image is enlarged according to the movement of the pointing device.

The location of another magnetic sensor is mapped to the location of the pointing device so that the user can manipulate the pointing device while holding the augmented reality service providing terminal. When the augmented reality service providing terminal is hidden, the camera tracking is lost. In order to prevent the failure of camera tracking, the magnetic sensor is disposed at another relative location of X axis and Y axis. In this manner, the location of the magnetic sensor of the pointing device is adjusted.

The mode switching unit 222 switches a reproduction mode or an interaction mode according to whether a sensing value corresponding to the tracking results of the tracking units 214 and 216 exceeds a threshold value under control of the control unit 218.

The interaction mode is a mode that is executed when a rotation angle of the magnetic sensor is less than a threshold value, renders the augmented reality image, and records a user's voice.

The threshold value is a rotation angle in the X axis perpendicular to the augmented reality service providing terminal. In the interaction mode, the augmented reality service providing terminal may render a predetermined 3D character background augmented-reality scene, and the reader may interact with an interactive 3D character and record his or her voice. This is stored in the DB 224.

The reproduction mode is executed when the augmented reality service providing terminal 200 is vertically maintained and the rotation angle of the magnetic sensor exceeds the threshold value, an animation 3D character is rendered through a virtual view, and a user's voice recorded in the interaction mode is output.

More specifically, the augmented reality service providing terminal, to which the present invention is applied, has the reproduction mode and the interaction mode. For example, the augmented reality service providing terminal can perform role playing by selecting an emotion of an interactive character and selecting a virtual dialog box.

In the interaction mode, the user can view the content provided by the augmented reality service providing terminal while wearing the wearable device, and can select the corresponding virtual scene or manipulate the corresponding virtual character.

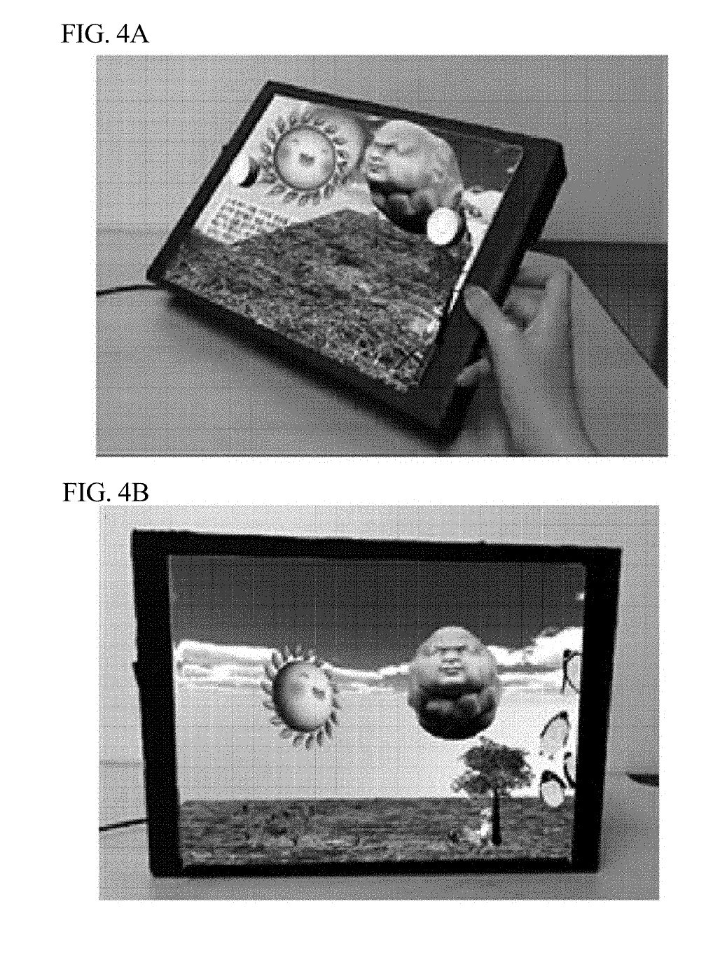

For example, from a child's point of view, a magic stick may appear and the magic stick may be manipulated by clicking a move icon. As illustrated in FIG. 4A and 4B, when the sun or wind is selected, three emotion icons and a microphone icon are activated around the interactive character. After the emition (happiness, sadness, and anger) between the sun and the wind, the child can select an appropriate emotion.

When the magic stick icon is touched, an icon color change is selected, and the user's own facial expression is changed according to the selected emotion corresponding to the sun and the wind. After viewing the facial expression change, the child selects the microphone icon and says the emotion or line from the sun or wind's point of view. The interaction mode provides the opportunity to change the viewpoint of the interaction. When the child holds the augmented reality service providing terminal in a vertical direction, the virtual scene is moved to the terminal and output according to the rotation of the terminal as illustrated in FIGS. 4 and 4B.

The operation of the augmented-reality-based interactive authoring-service-providing system according to the present invention can be achieved as described above. Meanwhile, specific embodiments of the present invention have been described, but various modifications may be made thereto without departing from the scope of the present invention. Therefore, the scope of the present invention is not defined by the embodiments, but should be defined by the appended claims and equivalents thereof

1. An augmented-reality-based interactive authoring-service-providing system comprising:
a wearable device including a head mounted display (HMD);
an augmented reality service providing terminal paired with the wearable device and configured to reproduce content corresponding to a scenario-based preset flow via a GUI interface, overlay corresponding objects in a three-dimensional (3D) space being viewed from the wearable device when an interrupt occurs in an object formed in the content to thereby generate an augmented reality image, convert a state of each of the overlaid objects according to a user's gesture, and convert location regions of the objects based on motion information sensed by a motion sensor; and
a pointing device including a magnetic sensor and configured to select or activate an object output from the augmented reality service providing terminal.

2. The augmented-reality-based interactive authoring-service-providing system of claim 1, wherein the augmented reality service providing terminal comprises:
a sensing unit configured to sense and output a type of a user's gesture;
a first tracking unit provided at a location opposite to a screen on which the GUI interface is displayed, and configured to detect a pose of an object, which is formed on each page corresponding to the content being reproduced, at each preset period;
a second tracking unit configured to sense and output a magnetic sensor movement path of the interworking pointing device;
a control unit configured to control a location of the object as content or a 3D space according to the type of the user's gesture, display preset facial expression items for each object so as to be adjacent to the object overlaid in the 3D space, convert the object so as to correspond to a facial expression item selected from the displayed items by the user, apply the converted object to the content, and acquire and apply pose information of the converted object according to the user's gesture through a database which stores standard pose information for each object included in a scenario-based content; and
a mode switching unit configured to switch a reproduction mode or an interaction mode according to whether a sensing value corresponding to a tracking result of the tracking units exceeds a threshold value under control of the control unit.

3. The augmented-reality-based interactive authoring-service-providing system of claim 2, wherein the interaction mode is a mode that is executed when a rotation angle of the magnetic sensor is less than a threshold value, renders an augmented reality image, and records a user's voice, and
the reproduction mode is executed when the rotation angle of the magnetic sensor exceeds the threshold value, an animation 3D character is rendered through a virtual view, and a user's voice recorded in the interaction mode is output.
